(19) United States
(12) Patent Application Publication
(10) Pub. No.: US 2008/0139233 A1
(43) Pub. Date: Jun. 12, 2008

(54) Power control method and apparatus for wireless communication system

(75) Inventor: Haitao Wang, Shanghai (CN)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/651,655

(22) Filed: Jan. 10, 2007

(30) Foreign Application Priority Data
Dec. 8, 2006 (CN) 200610162235.6

(51) Int. Cl. H04Q 7/20

(52) U.S. Cl. 455/522

(57) ABSTRACT

Open loop transmit power calculations made by a wireless communication receiving device use only the portion of the received signal power that is due to the transmitting device serving the wireless device, rather than using the total received power from all transmitting devices. In one embodiment a discernable signal trait of, such as a preamble, is used to identify signal power from a serving transmitter. In some embodiments, open loop power control may also used to transmit power limits established from closed loop power control sessions, in order to minimize power fluctuations. Digitally scaling data values compensates for transmitter power level settings by adjusting data values prior to modulation such that the modulated waveform contains a different power level than the original data values would provide.

### RELATED APPLICATIONS

This application is related to and claims priority to Chinese Application No. 200610162235.6 filed Dec. 8, 2006 entitled “POWER CONTROL METHOD AND APPARATUS FOR WIRELESS COMMUNICATION SYSTEM”, the disclosure of which is hereby incorporated herein by reference.

### TECHNICAL FIELD

The present invention relates generally to digital data transmission, and more particularly to improved methods and apparatus for providing open loop power control for a wireless communication system.

### BACKGROUND

In some wireless communication systems, such as, for example, orthogonal frequency division multiplexing (OFDM), time division duplexing (TDD) wireless communication systems, a transmitter, such as a mobile unit, must determine the power level required to meet the receiver's signal strength requirements. This may be done either by the receiver, such as a base station, feeding back information to the transmitter (close loop), or by the transmitter estimating its own transmit power requirement based on the power of a signal received from the base station (open loop).

Closed loop power control provides more accuracy, but at a cost of using extra bandwidth. Open loop power control does not use as much bandwidth, but does not have the same degree of accuracy. This is because the mobile unit calculates the path loss by comparing a local received power estimate for a signal from the base station against an indication of that signal's transmitted power. Errors in the estimate of received power from the base station signal can then produce errors in the calculation of the transmit power required for the mobile unit.

In a cellular-type system, in which multiple base stations each serve a particular cell, base stations may often produce interference in neighboring cells. Further, a base station serving multiple sectors of a cell with multiple transmitters may produce inter-sector interference. In either of these cases, when a mobile unit attempts to determine the signal power that is due to the serving transmitter, it also may include the interfering signals from other transmitters other than the serving transmitter in the estimate or measurement. This may occur because of frequency reuse plans in which different transmitters use the same frequencies. If the mobile unit sets its own transmit power on the total received signal power value (i.e., the power from the serving transmitter as well as power from other transmitters) the transmit power may be set to a non-optimal level.

Another challenge in power control is the use of multiple modulation schemes, in which the various schemes have different effective signal to noise ratio (SNR) requirements. For example, when changing from Quadrature Phase Shift Keying (QPSK) to 16 Quadrature Amplitude Modulation (16 QAM), about 6 dB increase in signal power may be required in order to maintain the same demodulation quality under the non-fading channel. If a transmit power level is set while using QPSK, and the system changes to 16 QAM without increasing the transmitter power level, possibly because the transmitter is already set to the maximum power level, the received demodulated signal may experience an increase in bit error rate (BER). Alternatively, if a transmit power level is set while using 16 QAM, and the system changes to QPSK without decreasing the transmitter power level, the transmitter may be causing unnecessary interference and wasting power.

### SUMMARY

Open loop transmit power calculations made by a wireless communication receiving device use only the portion of the received signal power that is due to the transmitting device serving the wireless device, rather than using the total received power from all transmitting devices. In one embodiment a discernable signal trait of, such as a preamble, is used to identify signal power from a serving transmitter. In some embodiments, open loop power control may also use transmit power limits established from closed loop power control sessions, in order to minimize power fluctuations. Digitally scaling data values compensates for transmitter power level settings by adjusting data values prior to modulation such that the modulated waveform contains a different power level than the original data values would provide.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIGS. 1A and 1B show one embodiment of a method for performing open loop power control in accordance with the present invention;

FIG. 2 shows one embodiment of a method for alternating closed loop and open loop power control in accordance with the present invention;

FIG. 3A shows an exemplary constellation of 16 QAM signals;

FIG. 3B depicts a digital scaling using an exemplary constellation of 16 QAM signals, in accordance with the present invention; and

FIG. 4 shows a system adapted to perform power control in accordance with an embodiment of the present invention.

### BACKGROUND OF THE INVENTION

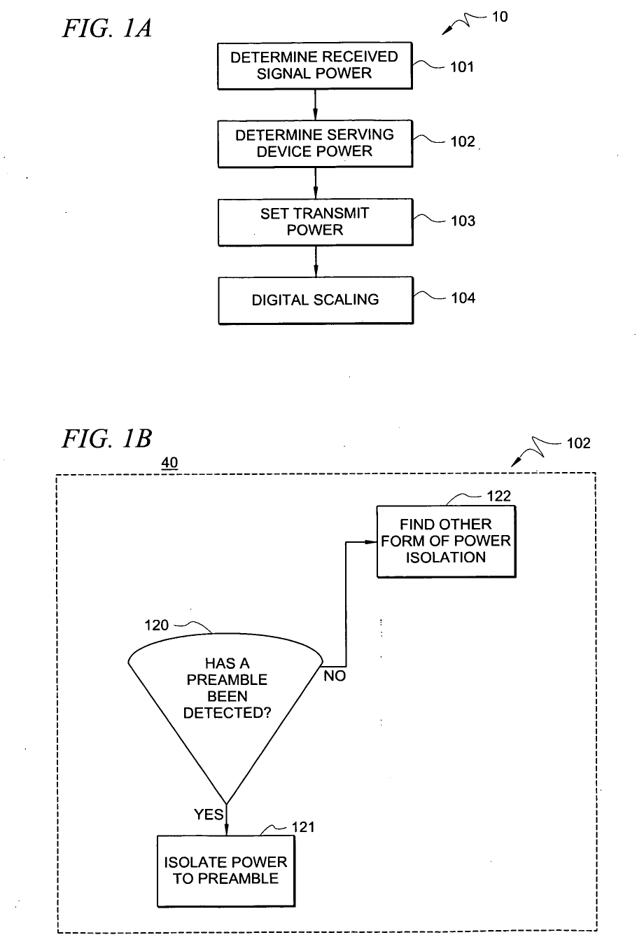

FIG. 1A shows one embodiment, for example method 10, for performing open loop power control in accordance with the present invention. The processes discussed with respect to FIGS. 1A and 1B can be performed in a processor, such as processor 403, FIG. 4.

The received signal power is determined by process 101, either through measurement, estimation, or using another suitable manner. For example, a received signal strength indication (RSSI) may be used. This power level determination, however, may include power from neighboring cells or transmitters serving other sectors of a cell. That is, the power level may include a portion that is due to the serving transmitter (serving device), and a portion that is due to other transmitters (devices that are not the serving device).

Since the required transmitter power is calculated for open loop power control based on the difference between an incoming signal's original power and received power, errors in the determination of received power are likely to produce errors in the calculation of the required transmitter power. Thus, interference from other transmitters may be a source of error. To reduce this error, the power due to the serving device alone is determined in process 102.

Typical cellular system base stations transmit preambles or other identifying information, along with data. This identifying information may be used to determine the relative power level of the signal components that comprise the total received power. For example, as shown in FIG. 1B the preamble from the serving transmitter can be identified by process 120 and the signal power contained in the serving transmitter's preamble may be determined, for example, by process 121. The isolated preamble power value may be used for the open loop calculations.

Alternatively, if process 120 does not detect a preamble (or if the preamble does not yield a proper power level, process 122 may identify signal characteristics from neighboring cells or other transmitters may be cross-correlated with the received signal so as to enable the removal of energy associated with those signals from the received signal. The remaining signal power is then determined to represent the signal from the serving transmitter. Any discernable signal trait, which allows identification or association of signal power with a transmitter may be used by process 122.

Using the determination of received signal power from the serving transmitter, process 103 sets the mobile device's transmitter power level. The serving transmitter will often transmit not only its own transmission power level, but also the power level it requires for proper reception. The mobile device uses this information to calculate the path loss and its own minimum transmit power.

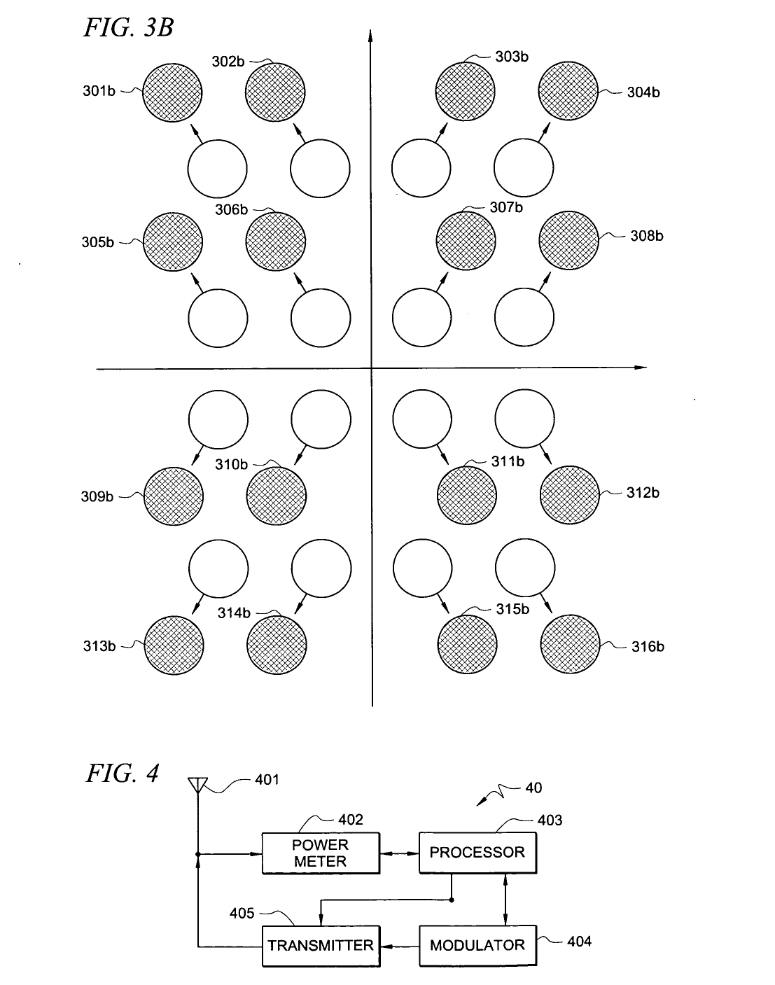

An OFDM-TDD system may often mix modulation schemes, but as noted above, the different modulation schemes may have different required SNRs. If the transmit power has been set during a period when QPSK was being used, the SNR might not be high enough for all of the 16 QAM words. Thus, method 10 may further perform digital scaling via process 104. Digital scaling will be described below, with respect to the discussion of FIGS. 3A-3C.

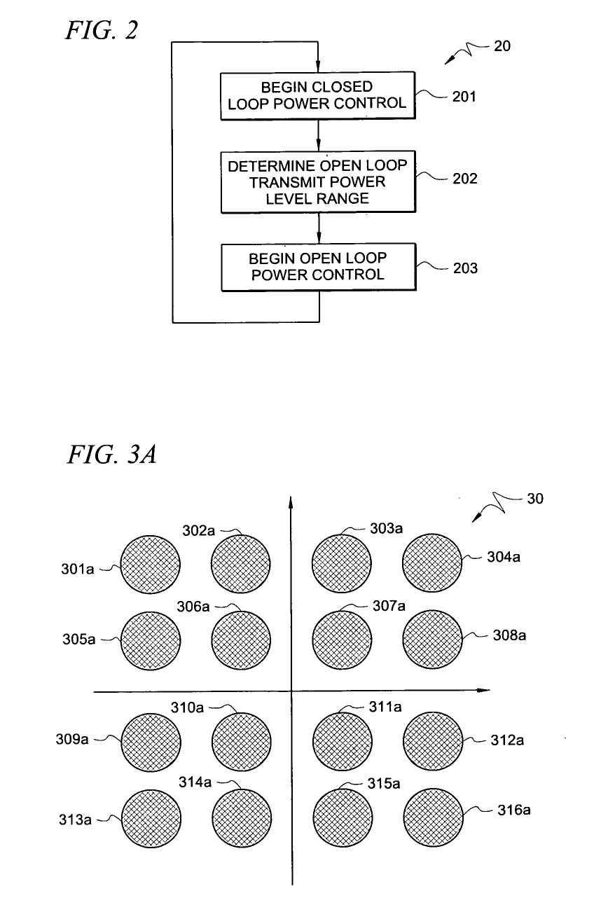

FIG. 2 shows one embodiment, such as method 20, for alternating closed loop and open loop power control in accordance with the present invention. Closed loop power control may be used when system operations allow, such as on a periodic basis. Open loop power control will then be used during the time intervals between periods of closed loop power control. This alternating arrangement takes advantage of the accuracy of closed loop control when it s available, but without requiring the same amount of bandwidth as full-time closed loop control. During periods of open loop control, the power calculations are subject to errors, which may be more pronounced for a fast fading channel. One way to reduce the effect of errors on the open loop calculations is to set a range of acceptable transmit power levels that is based on the power level used during closed loop control. Using a window that is established using a more accurate standard (closed loop feedback) will prevent spurious open loop calculations from causing excessive power fluctuations. That is, when open loop calculations indicate a transmit power outside the pre-defined window, the range window limit is used rather than the calculated value. The range limits may be either absolute power levels, or may be defined in terms of time, such as a maximum rate of power level change.

Closed loop power control begins with process 201, although method 20 could begin with either process 201 or with process 203. During process 202, the acceptable range for open loop power levels is set, and/or the rate of change of the power levels. Open loop control begins with process 203, and when system resources allow, closed loop power control begins again with process 201.

Digital scaling is explained by way of FIGS. 3A and 3B. FIG. 3A shows a constellation 30 for 16 QAM signals, before digital scaling. Constellation 30 is a four by four rectilinear arrangement comprising 16 signals, numbered 301a-316a. The axis of the plots represent the relative phase and intensity for two different signal bases. It can be seen from FIG. 3A that different signals have different power levels. For example, signal 304a has more power than signal 307a, even though they both contain the same ratio of signal bases. This power difference exists for every transmitter power level setting. That is, whether a transmitter is set to maximum or minimum power, signal 304a will still be transmitted with more power than signal 307a. Thus, even if a transmitter is set to a maximum level, signal 307a will not be transmitted with the maximum amount of power possible for the transmitter to produce. If the noise or interference level is high, it is possible that when signal 304a produces a barely acceptable SNR level, signal 307 may fall below an acceptable SNR level.

FIG. 3B shows constellation 30 after digital scaling. As seen, signals 301b-316b have been scaled from their original position, as shown in FIG. 3A. Again, constellation 30 is a rectilinear arrangement of 16 QAM signals. In comparing FIGS. 3A and 3B, it is seen that constellation 30 contains relatively low power for a given transmitter setting before scaling (FIG. 3A), and relatively high power for a given transmitter after scaling (FIG. 3B). Data which would produce such modulated signals may be adjusted prior to modulation, in order to produce modulated signals 301b-316b of constellation 30. Such a change may be necessary, when the SNR requirement changes, as discussed above for modulation changes from QPSK to 16 QAM, but the mobile unit does not adjust the transmitter power level setting.

FIG. 4 shows system 40 adapted to perform power control in accordance with an embodiment of the present invention. Signals received at antenna 401 include both the signal from the serving transmitter and signals from other transmitters as discussed above. Power meter 402 determines the received signal power value. The combination of power meter 402 and processor 403 determine the portion of the received signal power that is due to the serving transmitter. Processor 403 also sets the power of transmitter 405 and controls transitions between open lop and closed loop power control periods. Processor 403 and modulator 404 also perform data modulation with digital scaling. Modulator 404 provides signals to transmitter 405 which are then sent over antenna 401.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing open loop power control in a receiving device, said method comprising:
determining a received signal power value;
determining a portion of said received signal power value that is due to a transmitting device serving said receiving device; and
setting transmit power levels from said receiving device based on the portion of a determined received signal power value due to said serving device.

2. The method of claim 1 further comprising:
alternating periods of closed loop power control with periods of said open loop power control.

3. The method of claim 2 further comprising:
limiting transmit power levels used during said periods of open loop power control based on power levels used during said periods of closed loop power control.

4. The method of claim 1 further comprising:
digitally scaling data to be transmitted, wherein said digital scaling adjusts transmitted signal power levels without requiring a change in a power level setting of a transmitter.

5. The method of claim 4 wherein digitally scaling data comprises:
adjusting values of said data prior to modulation such that a modulated form of said adjusted data values produces a different transmitted power level than would a modulated form of original values of said data.

6. The method of claim 1 wherein said determining a portion comprises:
removing signal power values that are a result of power received from transmitting devices not currently serving said receiving device.

7. The method of claim 6 wherein said removing signal power values comprises:
determining, based on preamble power levels, said signal power values that are a result of power received from transmitting devices not currently serving said receiving device.

8. A method for providing power control in a communication system comprising:
alternating closed loop power control with open loop power control; and
digitally scaling data to be transmitted, wherein said digital scaling adjusts transmitted signal power levels without requiring a change in a power level setting of a transmitter.

9. The method of claim 8 wherein digitally scaling data comprises:
adjusting values of said data prior to modulation such that a modulated form of said adjusted data values produces a different transmitted power level than would a modulated form of original values of said data.

10. The method of claim 9 wherein digitally scaling data further comprises:
adjusting said adjusted data values after demodulation to said original data values.

11. The method of claim 8 further comprising:
limiting transmit power levels used during said periods of open loop power control based on power levels used during said periods of closed loop power control.

12. The method of claim 8 wherein said open loop power control comprises:
determining a received signal power value;
determining a portion of said received signal power value that is due to a transmitting device serving said receiving device; and
setting transmit power levels from said receiving device based on the portion of a determined received signal power value due to said serving device.

13. The method of claim 12 wherein said determining a portion comprises:
removing signal power values that are a result of power received from transmitting devices not currently serving said receiving device.

14. The method of claim 13 wherein said removing signal power values comprises:
determining, based on preamble power levels, said signal power values that are a result of power received from transmitting devices not currently serving said receiving device.

15. A wireless communication device comprising:
a transmitter having an adjustable power setting;
a receiver; and
one or more processors, wherein at least one of said processors is coupled to said receiver and is operable, in conjunction with said receiver, to determine a received signal power value that is due to a transmitting device serving said communication device, and wherein at least one of said processors is operable to adjust a power level of said transmitter based on said determined received signal power value.

16. The device of claim 15 wherein said determining a received signal power value comprises:
removing signal power values that are a result of power received from transmitting devices not currently serving said receiving device.

17. The device of claim 16 wherein said removing signal power values comprises:
determining, based on preamble power levels, said signal power values that are a result of power received from transmitting devices not currently serving said receiving device.

18. The device of claim 15 further comprising:
a modulator coupled to at least one of said processors, said modulator operable to modulate a signal with data to be transmitted.

19. The device of claim 18 wherein said processor coupled to said modulator is operable, in conjunction with said modulator, to digitally scale said data, wherein said digital scaling adjusts values of said data prior to said modulation such that a modulated form of said adjusted data values produces a different transmitted power level than would a modulated form of original values of said data.

20. The device of claim 15 wherein at least one of said processors is operable to alternate power control between closed loop operation and open loop operation and at least one of said processors is operable to limit transmit power levels used during periods of said open loop power control based on power levels used during periods of said closed loop power control.
